(19) United States
(12) Patent Application Publication
(10) Pub. No.: US 2011/0022821 A1
(43) Pub. Date: Jan. 27, 2011

(54) System and Methods to Improve Efficiency of VLIW Processors

(76) Inventors: Yunsi Fei, Tolland, CT (US); Hai Lin, Northampton, MA (US)

Correspondence Address: MCCARTER & ENGLISH, LLP STAMFORD, CANTERBURY GREEN, 201 BROAD STREET, 9TH FLOOR, STAMFORD, CT, 06901, US

(21) Appl. No.: 12/719,823

(22) Filed: Mar. 8, 2010

Related U.S. Application Data
(60) Provisional application No. 61/209,653, filed on Mar. 9, 2009.

(51) Int. Cl. G06F 9/30; G06F 15/00

(52) U.S. Cl. 712/32; 712/E09.016

(57) ABSTRACT

Exemplary embodiments provide microprocessors and methods to implement instruction packing techniques in a multiple-issue microprocessor. Exemplary instruction packing techniques implement instruction grouping vertically along packed groups of consecutive instructions, and horizontally along instruction slots of a multiple-issue microprocessor. In an exemplary embodiment, an instruction packing technique is implemented in a very long instruction word (VLIW) architecture designed to take advantage of instruction level parallelism (ILP).

### RELATED APPLICATIONS

This application is related to and claims priority to U.S. Provisional Application Ser. No. 61/209,653, filed Mar. 9, 2009, the entire contents of which are incorporated herein by reference.

This invention was made with Government support under (NSF Grant CCF-0541102) awarded by the National Science Foundation. The Government has certain rights in this invention.

### FIELD OF THE INVENTION

Exemplary embodiments generally relate to optimizing the efficiency of microprocessor designs. More specifically, exemplary embodiments provide microprocessors and methods for harnessing horizontal instruction parallelism and vertical instruction packing of programs to improve overall system efficiency.

### BACKGROUND

Microprocessor designs, whether for general purpose or embedded systems, are continuously pushing for optimization of performance, power consumption and cost. However, various hardware and software design technologies often target one or more design goals at the expense of others. One example of an optimization technique is horizontal instruction parallelism or instruction level parallelism (ILP). Horizontal instruction parallelism occurs when multiple independent operations can be executed simultaneously. In processors, horizontal instruction parallelism is utilized by having multiple functional units that run in parallel. Horizontal instruction parallelism has been exploited in both very-long-instruction-word (VLIW) and superscalar processors for performance improvement and for reducing the pressure on system clock frequency increase.

Superscalar architectures rely on complex instruction decoding and dispatching hardware for run-time data dependency detection and parallel instruction identification. VLIW technology, however, groups parallel instructions in a long word format, and reduces the hardware complexity by maintaining simple pipeline architectures and allowing compilers to control the scheduling of independent operations. Hence, VLIW technology has large flexibility to optimize the code sequence and exploit the maximum ILP. This feature of VLIW architecture makes it a good candidate for high performance embedded system implementation. Currently, the research on VLIW mainly focuses on compilation algorithms and hardware enhancement that can fully utilize the ILP and reduce waste of instruction slots, improving the performance and reducing the program memory space, cache space, and bus bandwidth. However, the performance improvement is usually achieved at the cost of power consumption, and techniques for both power consumption reduction and performance improvement are not fully explored.

Both performance and energy consumption are important to modern processors. There has been some research work that focuses on balancing energy consumption and performance trade-offs for multiple-issue processors. Various approaches have been taken to reduce power consumption of hot spots in processors. For example, the idea of instruction grouping has been employed to reduce the energy consumption of superscalar processors for storing instructions in the instruction queue and selecting and waking up instructions at the instruction issue stage. However, these techniques require on-line instruction grouping algorithms and result in complex hardware implementation for run-time group detection. The techniques are not flexible in instruction packing, with limited grouping patterns. Moreover, the techniques lack the ability to physically pack instructions to reduce the hardware cost, program code size, and energy consumption in memory. In one example, the program code size and the memory access energy cost was reduced in VLIW architectures by applying instruction compression/decompression between memory and cache. However, this technique also requires complex compression algorithms and hardware implementation, and the power consumption of the processor has not been effectively reduced.

Some techniques introduce the instruction register file (IRF) as a counterpart of data register file for instructions. An IRF is an on-chip storage that stores frequently occurring instructions in a program. Based on profiling information, frequently occurring instructions are placed in the on-chip IRF, and multiple entries in the IRF can be referenced by a single packed memory instruction. Both the number of instruction fetches and the program memory energy consumption are greatly reduced by using IRF technology. With position registers and a table storing frequently used immediate values, this technique applies successfully to single-issue processors. However, the performance improvement achieved by the IRF technology in single-issue processors is trivial.

### SUMMARY

Multiple-issue microprocessors can exploit instruction level parallelism (ILP) of programs to greatly improve performance. However, reduction of energy consumption while maintaining high performance of programs running on multiple-issue microprocessors remains a challenging problem. As used herein, a multiple-issue microprocessor is a processor including a set of functional units for parallel processing of a plurality of instructions. As used herein, instruction level parallelism (ILP) is a measure of how many of the operations in a computer program can be performed simultaneously.

In addressing this problem, exemplary embodiments apply the vertical instruction packing technique of instruction register files (IRF) to multiple-issue microprocessor architectures which employ ILP. Exemplary embodiments select frequently executed instructions to be placed in an on-chip IRF for fast access in program execution. Exemplary embodiments avoid violation of synchronization among multiple-issue microprocessor instruction slots by introducing new instruction formats and micro-architectural support. The enhanced multiple-issue microprocessor architecture provided by exemplary embodiments is thus able to implement horizontal instruction parallelism and vertical instruction packing for programs to improve overall system efficiency, including reduction in power consumption.

The vertical instruction packing technique employed by exemplary embodiments of multiple-issue microprocessors as taught herein reduces the instruction fetch power consumption, which occupies a large portion of the overall power consumption of multiple-issue microprocessors. The principle of “fetch-one-and-execute-multiple” (through vertical instruction packing and decoding) utilized by exemplary embodiments as taught herein also decreases program code size, reduces cache misses, and further improves performance. By applying architectural changes and instruction set architecture (ISA) modifications, and program modifications, exemplary embodiments bring the advantages of the IRF technique to the domain of multiple-issue microprocessors, thereby harnessing both horizontal instruction parallelism and vertical instruction packing of programs for system overall efficiency improvement.

### BRIEF DESCRIPTION OF THE DRAWINGS

The foregoing and other objects, aspects, features, and advantages of exemplary embodiments will become more apparent and may be better understood by referring to the following description taken in conjunction with the accompanying drawings, in which:

FIG. 1 (prior art) illustrates an exemplary format for an IRF-accessing sub-instruction that can occupy one instruction slot in a multiple-issue microprocessor.

FIG. 2 (prior art) illustrates an exemplary fetch-decode-execute cycle that takes places in a processor.

FIG. 3 (prior art) illustrates an exemplary pipeline used to implement IRFs in a single-issue processor.

FIG. 4 (prior art) illustrates an exemplary insertion of regular sub-instructions into multiple-issue instruction slots.

FIG. 5 illustrates an exemplary instruction sequence for a multiple-issue microprocessor.

FIG. 6 (prior art) illustrates direct packing of the instruction sequence of FIG. 5.

FIG. 7 illustrates an exemplary register instruction set architecture (RISA) format.

FIG. 8 illustrates an exemplary memory instruction set architecture (MISA) format.

FIG. 9 illustrates an exemplary parallel instruction set architecture (PISA) format provided in accordance with exemplary embodiments.

FIG. 10 illustrates an exemplary sequential instruction set architecture (SISA) format provided in accordance with exemplary embodiments.

FIG. 11 illustrates an exemplary method to implement IRFs in an exemplary two-way very-long-instruction-word (VLIW) processor, provided in accordance with exemplary embodiments.

FIG. 12 illustrates an exemplary reorganization and rescheduling of the instruction sequence of FIG. 5 in accordance with the method of FIG. 11, provided in accordance with exemplary embodiments.

FIGS. 13A and 13B illustrate cycle-accurate behavior of two pipes of a two-way VLIW processor with IRFs implemented by exemplary embodiments.

FIG. 14 illustrates a schematic drawing of an exemplary pipeline used to implement IRFs in a multiple-issue microprocessor, in accordance with exemplary embodiments.

FIG. 15 schematically illustrates an exemplary pipeline used to implement IRFs in a multiple-issue microprocessor, in accordance with exemplary embodiments.

FIG. 16 is a bar graph of code reduction over eight benchmarks applications executed by instruction packing in accordance with exemplary embodiments.

FIG. 17 is a table that shows the instruction fetch numbers under different IRF implementations provided by exemplary embodiments.

FIG. 18 is a bar graph of fetch energy reduction achieved by exemplary embodiments.

FIG. 19 is a block diagram of an exemplary computer system for implementing a multiple-issue microprocessor in accordance with exemplary embodiments.

### DETAILED DESCRIPTION

Exemplary embodiments employ vertical instruction packing in a multiple-issue microprocessor to achieve greater computational efficiency without violating synchronization among the different instruction slots. Exemplary embodiments also reduce the instruction fetch power consumption, which occupies a large portion of the overall power consumption of the processors. Exemplary embodiments implement an on-chip instruction register file (IRF) in a multiple-issue microprocessor. An IRF is an on-chip storage in which frequently occurring instructions are placed. Multiple entries in the IRF can be referenced by a single packed instruction in ROM or L1 instruction cache. The principle of “fetch-one-and-execute-multiple” (through vertical instruction packing and decoding) can greatly reduce power consumption, decrease program code size, and reduce cache misses. To achieve these improvements, exemplary embodiments taught herein disclose architectural changes and instruction set architecture (ISA) and program modifications to incorporate an IRF technique into the very-long-instruction-word (VLIW) domain by advantageously harnessing both horizontal instruction parallelism and vertical instruction packing of programs for overall microprocessor efficiency improvement.

As used herein, a microprocessor is a processing unit that incorporates the functions of a computer's central processing unit (CPU). A microprocessor may be a single-core processor with a single core, or a multi-core processor having one or more independent cores that may be coupled together. Each core may incorporate the functions of a CPU.

As used herein, a single-issue microprocessor is a microprocessor that issues a single instruction in every pipeline stage. A multiple-issue microprocessor is a microprocessor that issues multiple instructions in every pipeline stage. Examples of multiple-issue microprocessors include superscalar processors and very-long-instruction-word (VLIW) processors.

Instruction packing is a compiler/architectural technique that seeks to improve the traditional instruction fetch mechanism by placing the frequently accessed instructions into an instruction register file (IRF). The instructions in the IRF can be referenced by a single packed instruction in ROM or a L1 instruction cache (IC). Such packed instructions not only reduce the code size of an application, improving spatial locality, but also allow for reduced energy consumption, since the instruction cache does not need to be accessed as frequently. The combination of reduced code size and improved fetch access can also translate into reductions in execution time. Further discussion of instruction register files can be found in S. Hines, J. Green, G. Tyson, and D. Whalley, “Improving program efficiency by packing instructions into registers,” in Proc. Int. Symp. Computer Architecture, pages 260-271, May 2005, and S. Hines, G. Tyson, and D. Whally, “Improving the energy and execution efficiency of a small instruction cache by using an instruction register file,” in Proc. Of Watson Conf. on Interaction between Architecture, Circuits, & Compilers, pages 160-169, September 2005, both of which are incorporated herein by reference.

Multiple entries in an IRF can be referenced by a single packed instruction in the ROM or L1 instruction cache. As such, corresponding sub-streams of instructions in the application can be grouped and replaced by single packed instructions. The real instructions contained in the IRF are referred to herein as register ISA (RISA) instructions, and the packed instructions which reference the RISA instructions are referred to herein as Memory ISA (MISA) instructions. A group of RISA instructions can be replaced by a compact MISA instruction. A compact MISA instruction contains several indices in one instruction word for referencing multiple entries in the IRF. The indices in the MISA instruction are used in the first half of the decode state of the pipeline to refer to the RISA instructions in the IRF.

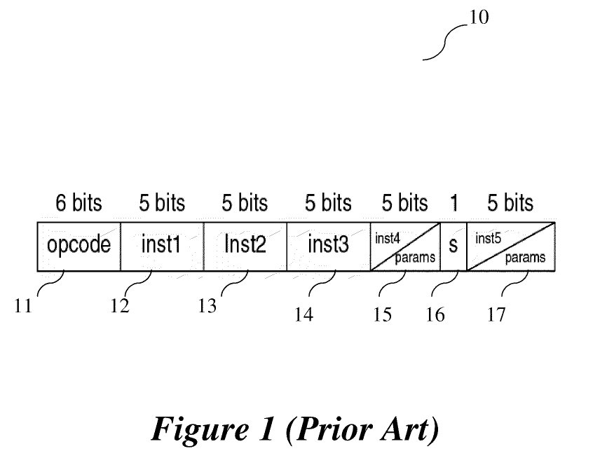

FIG. 1 (prior art) illustrates an exemplary packed MISA instruction format 10. The MISA instruction format 10 includes an operation code field (opcode) 11 which specifies the operation to be performed. The MISA instruction format 10 also includes one or more instruction identifiers 12, 13, 14, each referencing a RISA instruction. Each instruction identifier includes a register specifier used to index the corresponding RISA instruction referenced by the instruction identifier. The MISA instruction format 10 further includes an S-bit 16 that controls sign extension. The MISA instruction format 10 also includes one or more parameter identifiers 15, 17, each referencing an immediate value in an immediate table that is frequently used by the instruction.

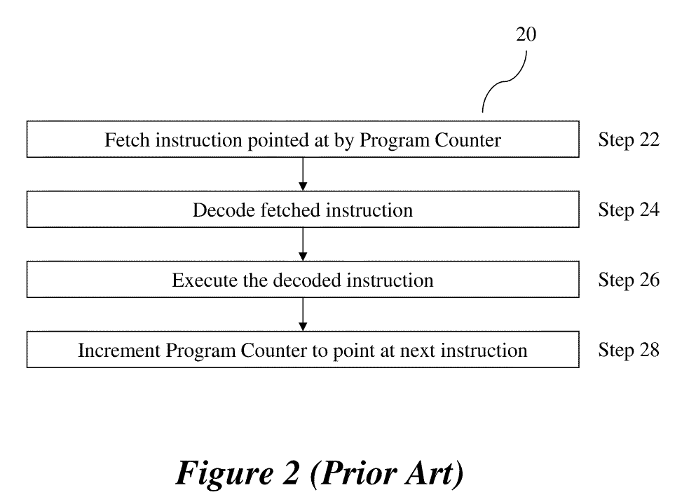

FIG. 2 (prior art) illustrates an exemplary fetch-decode-execute cycle 20 that takes place in a processor. A fetch-decode-execute cycle is the time period during which a computer processes a machine language instruction from memory or the sequence of actions that a processor performs to execute each machine language instruction in a program. In step 22, the processor fetches an instruction pointed at by the Program Counter (PC) from an instruction cache or memory. The Program Counter (PC) is a register inside the processor that stores the memory address of the current instruction being executed or the next instruction to be executed. In step 24, the processor decodes the fetched instruction so that it can be interpreted by the processor. Once decoded, in step 26, the processor executes the instruction. In step 28, the Program Counter (PC) is incremented so that the next instruction may be fetched in the next fetch-decode-execute cycle.

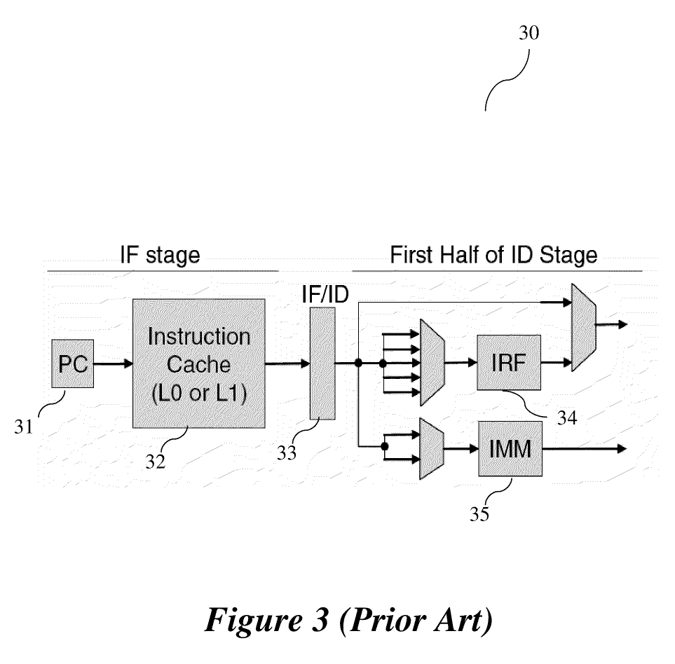

FIG. 3 (prior art) illustrates a pipeline 30 used to implement a conventional packing methodology using an instruction register file (IRF) in a single-issue processor. The pipeline 30 includes a program counter (PC) 31 which holds, during operation of the processor, the address of the instruction being executed or the address of the next instruction to be executed. The pipeline 30 also includes an instruction cache 32 which holds the instruction to be fetched based on the program counter 31. The instruction cache 32 may be implemented using different types of memory including, but not limited to, L0 instruction cache, L1 instruction cache, ROM, etc.

During the instruction fetch (IF) stage of the instruction cycle, the instruction whose address is held in the program counter 31 is fetched from the instruction cache 32. The instruction may be a single instruction or a packed instruction, referred to herein as a MISA instruction, which contains several indices in one instruction word for referencing multiple entries in an instruction register file (IRF).

The pipeline 30 includes an instruction register file (IRF) 34 which includes registers for holding frequently accessed instructions or RISA instructions that are referenced by MISA instructions. The IRF 34 may be implemented using different types of memory including, but not limited, to random access memory (RAM), static random access memory (SRAM), etc. The pipeline 30 includes an immediate table (IMM) 35 which stores immediate values. Immediate values are commonly used immediate values in the program. Like the IRF 34, the immediate table 35 may be implemented using different types of memory including, but not limited to, RAM, SRAM, etc.

The pipeline 30 includes an instruction fetch/instruction decode (IF/ID) pipeline register 33 that holds the fetched instruction.

During the instruction decode (ID) stage of the instruction cycle, one or more instructions referenced by a MISA instruction fetched from the instruction cache 32 are referenced in the IRF 34. The instructions retrieved from the IRF 34 may be placed in an instruction buffer (not pictured) for execution in an execution module (not pictured). One or more immediate values used by the MISA instruction are also referenced in the immediate table 35.

By integrating an IRF in the single-issue architecture and allowing arbitrary combinations of RISA instructions in a MISA instruction, the program code size is decreased, the number of instruction fetches is reduced, and the energy consumed in fetching instructions is also reduced.

There are at least two ways of integrating an IRF in multiple-issue architectures. One methodology utilizes the horizontal instruction parallelism and vertical packing in an orthogonal manner, i.e., multiple-issue microprocessor compilation followed by IRF insertion. The RISA instructions put into the IRF are long-word instructions, and the size of each IRF entry is scaled accordingly. Program profiling for obtaining instruction frequency information and selecting RISA instructions is based on the long-word instructions. In this way, although the complexity of hardware and compiler modifications for supporting the IRF is the same as in single-issue architectures, this methodology loses much flexibility of instruction packing. Different combinations of the same sub-instructions would be considered different long instruction candidates, thus reducing the efficiency of IRF usage greatly.

Another methodology couples the horizontal instruction parallelism and vertical packing in a cooperative manner, i.e., multiple-issue microprocessor compilation and IRF insertion are integrated. In this configuration, an IRF stores the most frequently executed sub-instructions, and the size of each entry is the same as that for single-issue processors. The instruction packing is along the instruction slots. This approach allows higher flexibility in packing the most efficient RISA instructions for each instruction slot. Thus, the IRF resource is better utilized.

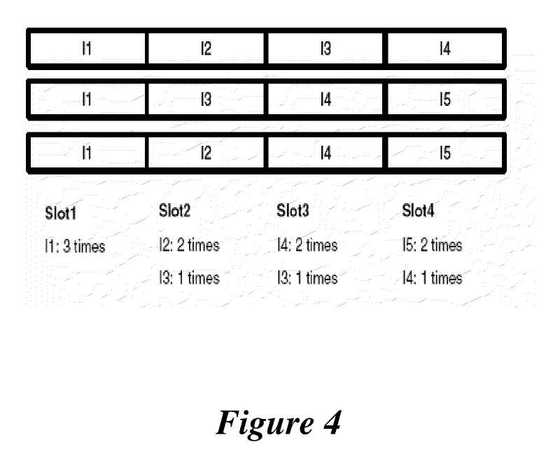

FIG. 4 (prior art) analyzes the execution frequency of sub-instructions in long-word instructions to determine what sub-instructions can be put in the IRF. At the profiling phase, there are three long instructions executed in a sequence, each with an execution frequency of one. If we have an IRF size of four sub-instructions, in the first way of putting long-word instructions in the IRF, there is only one entry in the IRF and one long instruction can be referenced. In the second way, each long instructions is broken down to sub-instructions, the most frequently executed sub-instructions are chosen and placed into the IRF, e.g., I1, I2, I4, and I5 in FIG. 4. A total number of 9 sub-instructions are referenced from the IRF instead of the cache. Thus, the second way can potentially save code size and cache access times.

A global IRF can be built with multiple ports across the slots, or an individual IRF can be dedicated to each slot. A global IRF is more capable in exploiting the execution frequency of sub-instructions among the slots when the VLIW pipes are homogeneous. However, separate IRFs are suitable when each instruction slot corresponds to certain execution units in the data path and is dedicated to a subset of the ISA.

Separate IRFs are adopted for different slots, as the pipes are heterogeneous in typical VLIW architectures. However, it is not feasible to directly pack sub-instructions of each instruction slot in VLIW architectures and maintain the horizontal instruction parallelism among the multi-way execution units. The original VLIW compiler schedules the instruction sequence. With an IRF inserted, the sub-instructions are packed for each slot. At an execution cycle, those instruction slots that receive such compact instructions refer to multiple RISAs in the IRF, and thus it takes multiple cycles to finish execution. Since the number of sub-instructions may vary among different slots, the original synchronized behavior of the slots may be destroyed and the parallelism between the independent operations cannot be guaranteed.

One of ordinary skill in the art will recognize that the pipeline illustrated in FIG. 3 is an exemplary pipeline that implements an instruction register file (IRF) and that variations are possible. One possible variation may be to place intermediate stages between the instruction fetch (IF) and instruction decode (ID) stages in the pipeline. Another possible variation may be to place the IRF 34 at the end of the instruction fetch stage. Yet another possible variation may be to store partially decoded instructions in the IRF 34.

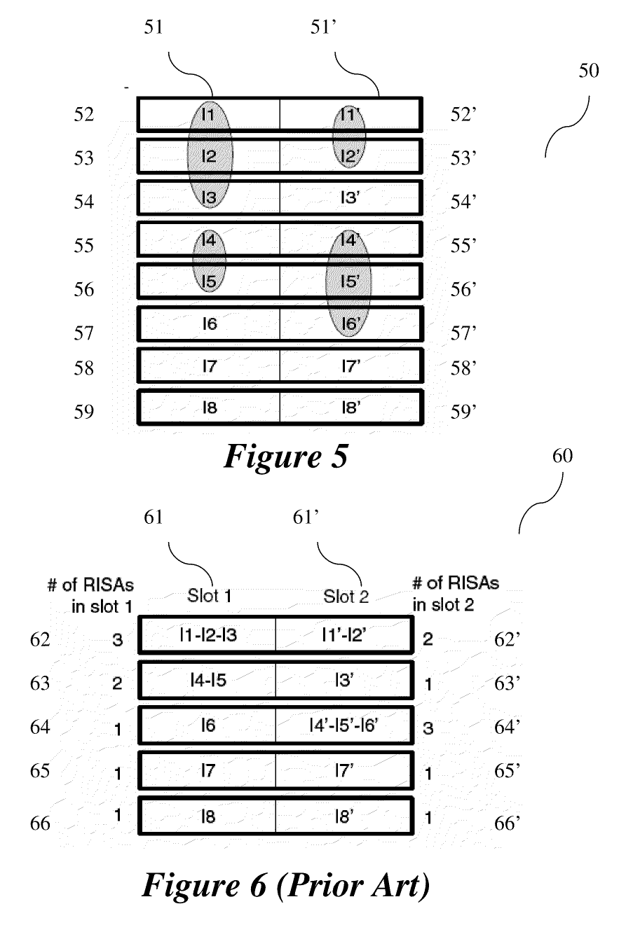

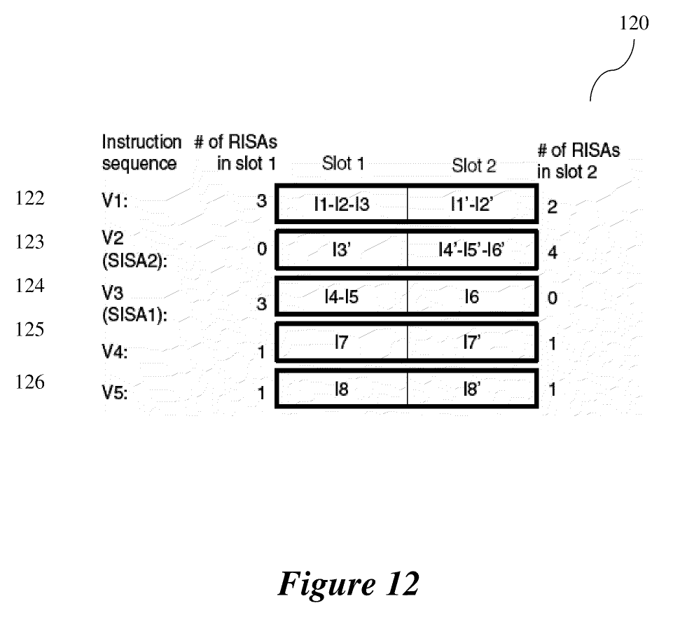

FIG. 5 illustrates an instruction sequence 50 for a multiple-issue microprocessor with two instruction pipelines. FIG. 5 is provided to facilitate the explanation and understanding of the present invention in comparison with conventional methods of instruction packing in a multiple-issue microprocessor. The same instruction sequence 50 of FIG. 5 is used to compare a conventional method of instruction packing in a multiple-issue microprocessor (as illustrated in FIG. 6) and an exemplary method provided by the present invention (as illustrated in FIG. 12).

In FIG. 5, the instruction sequence 50 has two instruction slots 51, 51′ for scheduling sub-instructions to pipe 1 and pipe 2 of the processor, respectively. FIG. 6 (prior art) illustrates a conventional technique of direct packing of the instruction sequence 50 of FIG. 5 to generate a reorganized instruction sequence 60. The first sub-instruction 62 in the first instruction slot 61 is part of a packed instruction including sub-instructions 52, 53, 54 [I1, I2, I3], and is scheduled for execution in instruction pipeline 1. The first sub-instruction 62′ in the second instruction slot 61′ is part of another packed instruction including sub-instructions 52′, 53′ [I1′, I2′], and is scheduled for execution in instruction pipeline 2.

The next sub-instruction 63 in the first instruction slot 61, immediately following the previous packed instruction above, is part of a packed instruction including sub-instructions 55, 56 [I4, I5], and is scheduled for execution in instruction pipeline 1. The next sub-instruction 63′ in the second instruction slot 61′, immediately following the previous packed instruction above, is a single instruction [I3′], and is scheduled for execution in instruction pipeline 2.

The next sub-instruction 64 in the first instruction slot 61, immediately following the previous packed instruction above, is a single instruction [I6], and is scheduled for execution in instruction pipeline 1. The next sub-instruction 64′ in the second instruction slot 61′, immediately following the previous single instruction above, is part of a packed instruction including sub-instructions 55′, 56′, 57′ [I4′, I5′, I6′], and is scheduled for execution in instruction pipeline 2.

The next sub-instruction 65 in the first instruction slot 61, immediately following the previous single instruction above, is a single instruction [I7], and is scheduled for execution in instruction pipeline 1. The next sub-instruction 65′ in the second instruction slot 61′, immediately following the previous packed instruction above, is a single instruction [I7′], and is scheduled for execution in instruction pipeline 2.

The next sub-instruction 66 in the first instruction slot 61, immediately following the previous single instruction above, is a single instruction [I8], and is scheduled for execution in instruction pipeline 1. The next sub-instruction 66′ in the second instruction slot 61′, immediately following the previous single instruction above, is a single instruction [I8′], and is scheduled for execution in instruction pipeline 2.

In instruction sequence 60, only when both the instruction slots in an instruction word have finished execution can the subsequent instruction word by executed. Thus, the first slot in the first pipeline [I1, I2, I3] takes three cycles to execute, with the second slot [I1′, I2′] idling in the third cycle. When the second instruction word is fetched and executed, one slot is executing two sub-instructions in a sequence [I4, I5], and the other slot is executing only one sub-instruction [I3′]. If there is a data dependency of I4 on I3′, for example, this instruction may have internal read-after-write (RAW) data hazard and may cause the processor to halt, stall or otherwise malfunction. Although the code size and the total number of instruction fetches are reduced, the behavior of the execution units is unsynchronized and may cause extra pipeline stalls.

To overcome these problems, exemplary embodiments provide program modifications and architecture enhancements to regain synchronization among all the execution units, as illustrated in FIGS. 10-15. Applying the IRF technique while maintaining synchronization among all the execution units allows exemplary embodiments to achieve the performance advantage of the multiple-issue architecture, reduce code size and reduce energy consumption.

The code reduction mechanism through IRF insertion provided by exemplary embodiments is orthogonal to traditional VLIW code compression algorithms. Conventionally, VLIW compiler statically schedules sub-instructions to exploit the maximum ILP, and No Operation Performed (NOP) instructions may be inserted in some instruction slots if the ILP is not wide enough. Since these NOP instructions introduce large code redundancy, state-of-the-art VLIW implementations usually apply code compression techniques to eliminate NOPs to reduce the code size in memory. Extra bits, such as head and tail, are inserted to the variable length instruction words to annotate the beginning and end of the long instructions in memory. A decompression logic is needed to retrieve the original fixed-length instruction words before they are fetched to processor.

As taught herein, instruction packing algorithms provided by exemplary embodiments lie along the vertical dimension, and no sub-instructions are eliminated in the long instruction word. The code is compressed in a way that one MISA instruction contains indices for referring to multiple RISAs in the on-chip IRF. Code compression takes place before the traditional code compression mechanisms, and is thus transparent to them.

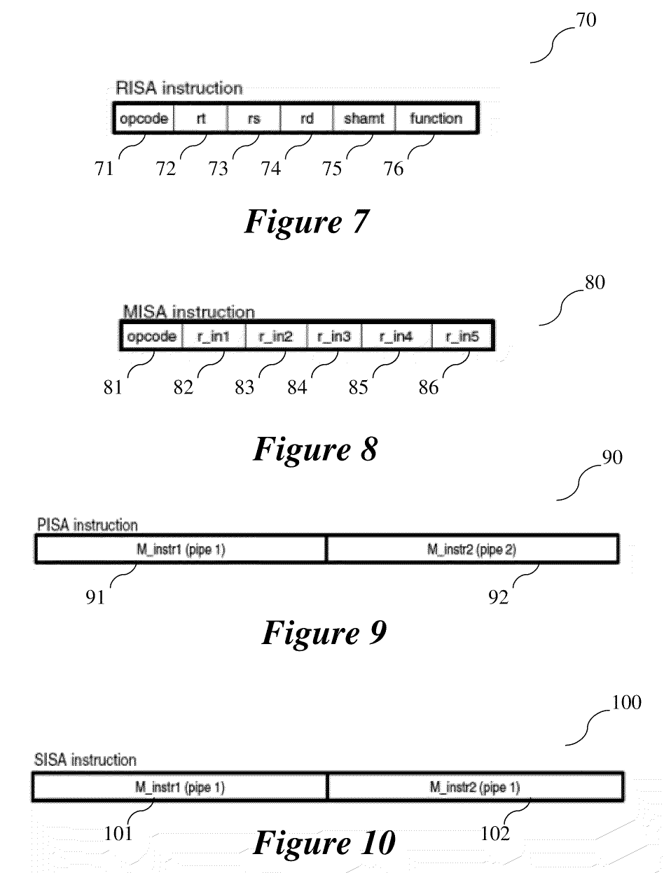

As illustrated in FIGS. 7-10, instructions related to instruction register files (IRF) are classified into four categories spanning two hierarchy levels. As taught herein, exemplary embodiments provide a new instruction format for instruction words in a multiple-issue microprocessor as illustrated in FIG. 10.

FIGS. 7 and 8 illustrate two exemplary instruction formats at the lower hierarchy level, each targeting an instruction slot in a multiple-issue microprocessor instruction. FIG. 7 illustrates an exemplary register instruction set architecture (RISA) instruction format 70 which represents a primary sub-instruction placed in an IRF, e.g. basic operations such as add_i. The format 70 may include an operation code 71, and one or more parameters 72-76 specifying the primary fields.

FIG. 8 illustrates an exemplary memory instruction set architecture (MISA) instruction format 80 which is a sub-instruction that can occupy one multiple-issue instruction slot. A MISA instruction may be a regular single sub-instruction, or may refer to a number of RISA instructions. The maximum number of RISA instructions that may be referred to in a single MISA instruction is limited by the instruction word length and the IRF size. The format 80 may include an operation code 81 and references to a number of RISA instructions 82-86.

FIGS. 9 and 10 illustrate two exemplary instruction formats at a higher hierarchy level, each targeting the whole multiple-issue instruction word stored in memory. Each instruction format consists of multiple MISA sub-instructions. FIG. 9 illustrates an exemplary parallel instruction set architecture (PISA) instruction format 90 which is a regular parallel long-word instruction. Each PISA instruction may contain one or more MISA sub-instructions 91, 92 in different instruction slots. At runtime, the MISA sub-instructions in different instruction slots are simultaneously dispatched to corresponding execution units (pipes) of the multiple-issue microprocessor. The format 90 may include a reference to a first MISA sub-instruction 91 scheduled for execution in pipe 1 (or pipe 2), and a reference to a second MISA sub-instruction 92 scheduled for execution in pipe 2 (or pipe 1).

FIG. 10 illustrates an exemplary sequential instruction set architecture (SISA) instruction format 100 which is a special long-word instruction. Each SISA instruction may contain one or more MISA sub-instructions in the same instruction slot. The SISA instruction is implemented by exemplary embodiments to compensate for the pace mismatch of sub-instruction sequences among instruction slots caused by the IRF-based instruction packing technique. At run-time, the MISA sub-instructions in different instruction slots are dispatched to one execution unit (pipe) in a sequential order. Several reserved bits in the SISA instruction word may be encoded to indicate the instruction type and its target pipe. The format 100 may include a reference to a first MISA instruction 101 scheduled for execution in one pipe, and a reference to a second MISA instruction 102 scheduled for execution in the same pipe.

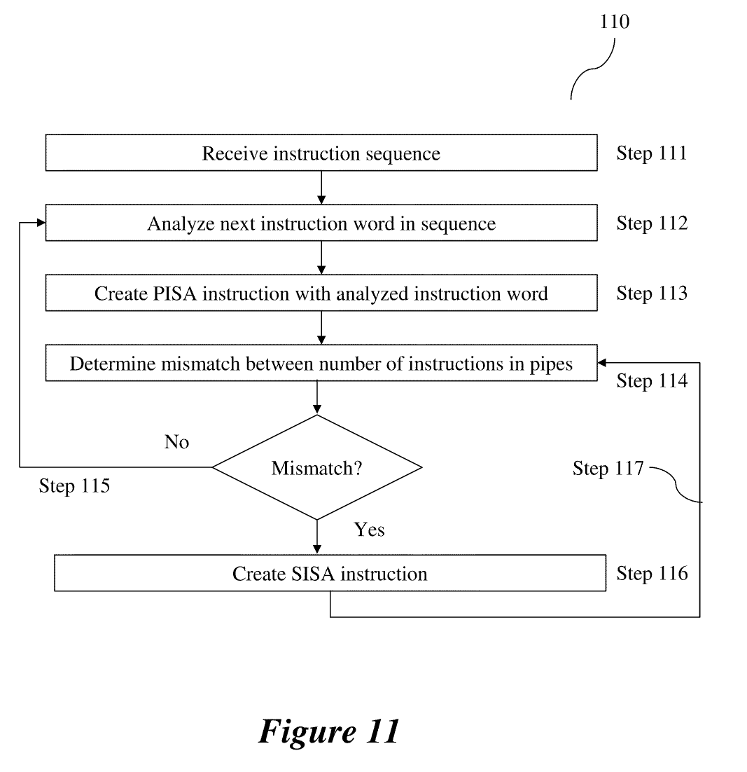

Exemplary embodiments also provide program recompilation and code rescheduling techniques for implementing instruction register files (IRF) in a multiple-issue microprocessor architecture. FIG. 11 illustrates an exemplary method 110 to implement IRFs in a two-way VLIW microprocessor having two pipes. In step 111, exemplary embodiments receive an instruction sequence of instruction words. Each instruction word consists of two parallel instruction slots to be packed into two pipes of a two-way VLIW processor. Each instruction slot contains a sub-instruction. As such, the instruction sequence may be thought of as including two vertically sequences of sub-instructions. There is at least one set of consecutive sub-instructions that may be packed together in a packed instruction.

In steps 112-116, exemplary embodiments re-organize and re-schedule the sub-instructions in the instruction sequence in a manner that is different from the direct packing method illustrated in FIG. 6. In step 112, exemplary embodiments analyze the first instruction word in the instruction sequence. The instruction word consists of two sub-instructions, one corresponding to each pipe of the processor. If the sub-instruction corresponding to pipe 1 is a single instruction, i.e. not part of a packed instruction, exemplary embodiments schedule the sub-instruction for execution in pipe 1 in step 113. Similarly, if the sub-instruction corresponding to pipe 2 is a single instruction, i.e. not part of a packed instruction, exemplary embodiments schedule the sub-instruction for execution in pipe 2 in step 113. In order to schedule the sub-instructions, exemplary embodiments create a PISA instruction composed of the two sub-instructions. The first slot of the PISA instruction is a MISA instruction containing the sub-instruction scheduled for execution in pipe 1. The second slot of the PISA instruction is a MISA instruction containing the sub-instruction scheduled for execution in pipe 2. This PISA instruction is the first instruction word that is packed into the two-way processor's instruction slots.

However, if the sub-instruction corresponding to pipe 1 is part of a packed instruction, exemplary embodiments schedule the entire packed instruction for execution in pipe 1 in step 113. Similarly, if the sub-instruction corresponding to pipe 2 is part of a packed instruction, exemplary embodiments schedule the entire packed instruction for execution in pipe 2 in step 113. In a case where the sub-instruction corresponding to pipe 1 is part of a packed instruction, the first slot of the PISA instruction is a MISA instruction containing the entire packed instruction. In a case where the sub-instruction corresponding to pipe 2 is part of a packed instruction, the second slot of the PISA instruction is a MISA instruction containing the entire packed instruction.

In step 114, exemplary embodiments analyze pipes 1 and 2 to determine if there is a mismatch between the total numbers of RISA instructions scheduled for the two pipes. For example, if pipe 1 is packed with one or more MISA instructions with a first number of total RISA instructions, and pipe 2 is packed with one or more MISA instructions with a second, different number of total RISA instructions, a mismatch is detected. A single instruction is counted as 1 sub-instruction. A packed instruction with n instructions is counted as n sub-instructions.

On the other hand, if pipe 1 is packed with one or more MISA instructions with a first number of total RISA instructions, and pipe 2 is packed with one or more MISA instructions with the same first number of total RISA instructions, a mismatch is not detected. In step 114, exemplary embodiments also determine which pipe has the fewer number of total RISA instructions.

If a mismatch is not detected in step 114, i.e., if the operation of the two pipes is synchronized, exemplary embodiments pack pipes 1 and 2 with the next instruction word in the instruction sequence by starting at step 112, as shown in step 115. However, if a mismatch is detected in step 114, i.e. if the operation of the two pipes is not synchronized, exemplary embodiments follow a different method for further packing pipes 1 and 2 with the next instruction word in the instruction sequence, as shown in step 116.

For the purposes of this example, we assume that pipe 2 has the fewer number of total RISA instructions. In step 116, exemplary embodiments look into the next two instructions words in the instruction sequence (say next_instr1 and next_instr2). The sub-instruction corresponding to pipe 2 in next_instr1 is scheduled for execution in pipe 2. The sub-instruction corresponding to pipe 2 in next_instr2 is scheduled for execution in pipe 2 in sequence. In order to schedule the sub-instructions, exemplary embodiments create a SISA instruction composed of the two sub-instructions. The first slot of the SISA instruction is a MISA instruction containing the sub-instruction in next_instr1 scheduled for execution in pipe 2. The second slot of the SISA instruction is a MISA instruction containing the sub-instruction in next_instr2 scheduled for execution in pipe 2.

Exemplary embodiments then return to step 114 to analyze pipes 1 and 2 to determine if there is a mismatch between the total numbers of RISA instructions between the two pipes, as shown in step 117.

FIG. 12 illustrates the instruction sequence of FIG. 5 reorganized and rescheduled according to the exemplary method of FIG. 11. The first sub-instruction 52 in the first instruction slot 51 of the instruction sequence 50 of FIG. 5 is part of a packed instruction [I1, I2, I3]. The first sub-instruction 52′ in the second instruction slot 51′ is part of another packed instruction [I1′, I2′]. Exemplary embodiments create a PISA instruction 122 with the first slot consisting of the entire packed instruction [I1, I2, I3] scheduled for execution in pipe 1, and the second slot consisting of the entire packed instruction [I1′, I2′] scheduled for execution in pipe 2.

FIG. 12 shows the PISA instruction 122 as the first instruction word in the reorganized instruction sequence 120. There are three RISA instructions scheduled for execution in pipe 1 and two RISA instructions scheduled for execution in pipe 2. As such, a mismatch is detected between the total numbers of RISA instructions scheduled for execution in the two pipes. Pipe 2 has fewer RISA instructions scheduled for execution.

The next sub-instruction 54′, immediately following the previous packed instruction above, in the second instruction slot 51′ of the instruction sequence 50 of FIG. 5, has a single instruction [I3′]. The next sub-instruction 55′, immediately following sub-instruction 54′ in the second instruction slot 51′, has a packed instruction [I4′, I5′, I6′]. Exemplary embodiments create a SISA instruction 123 with the first slot consisting of the single instruction [I3′] scheduled for execution in pipe 2, and the second slot consisting of the packed instruction [I4′, I5′, I6′] also scheduled for execution in pipe 2.

FIG. 12 shows the SISA instruction 123 as the second instruction word in the reorganized instruction sequence 120. There are three RISA instructions scheduled for execution in pipe 1 and six RISA instructions scheduled for execution in pipe 2. As such, another mismatch is detected between the total numbers of RISA instructions scheduled for execution in the two pipes. Pipe 1 has fewer RISA instructions scheduled for execution.

The next sub-instruction 55, immediately following the previous packed instruction above in the first instruction slot 51 of the instruction sequence 50 of FIG. 5, has a packed instruction [I4, I5]. The next sub-instruction 57, immediately following the previous packed instruction 55 above in the first instruction slot 51, has a single sub-instruction [I6]. Exemplary embodiments create a SISA instruction 124 with the first slot consisting of the packed instruction [I4, I5] scheduled for execution in pipe 1, and the second slot consisting of the single instruction [I6] scheduled for execution in pipe 1.

FIG. 12 shows the SISA instruction 124 as the third instruction word in the reorganized instruction sequence 120. There are six RISA instructions scheduled for execution in pipe 1 and six RISA instructions scheduled for execution in pipe 2. As such, no mismatch is detected between the total numbers of RISA instructions scheduled for execution in the two pipes.

The next sub-instruction 58, immediately following the sub-instruction above in the first instruction slot 51 of the instruction sequence 50 of FIG. 5, has a single instruction [I7]. The next sub-instruction 58′, immediately following the previous sub-instruction above in the second instruction slot 51′, has a single instruction [I7′]. Exemplary embodiments create a PISA instruction 125 with the first slot consisting of the instruction [I7] scheduled for execution in pipe 1, and the second slot consisting of the instruction [I7′] scheduled for execution in pipe 2.

FIG. 12 shows the PISA instruction 125 as the fourth instruction word in the reorganized instruction sequence 120. There are seven RISA instructions scheduled for execution in pipe 1 and seven RISA instructions scheduled for execution in pipe 2. As such, no mismatch is detected between the total number of RISA instructions scheduled for execution in the two pipes.

The next sub-instruction 59, immediately following the previous sub-instruction above in the first instruction slot 51 of the instruction sequence 50 of FIG. 5, has a single instruction [I8]. The next sub-instruction 59′, immediately following the previous sub-instruction above in the second instruction slot 51′, has a single instruction [I8′]. Exemplary embodiments create a PISA instruction 126 with the first slot consisting of the instruction [I8] scheduled for execution in pipe 1, and the second slot consisting of the instruction [I8′]scheduled for execution in pipe 2. FIG. 12 shows the SISA instruction 126 as the fifth and final instruction word in the reorganized instruction sequence 120.

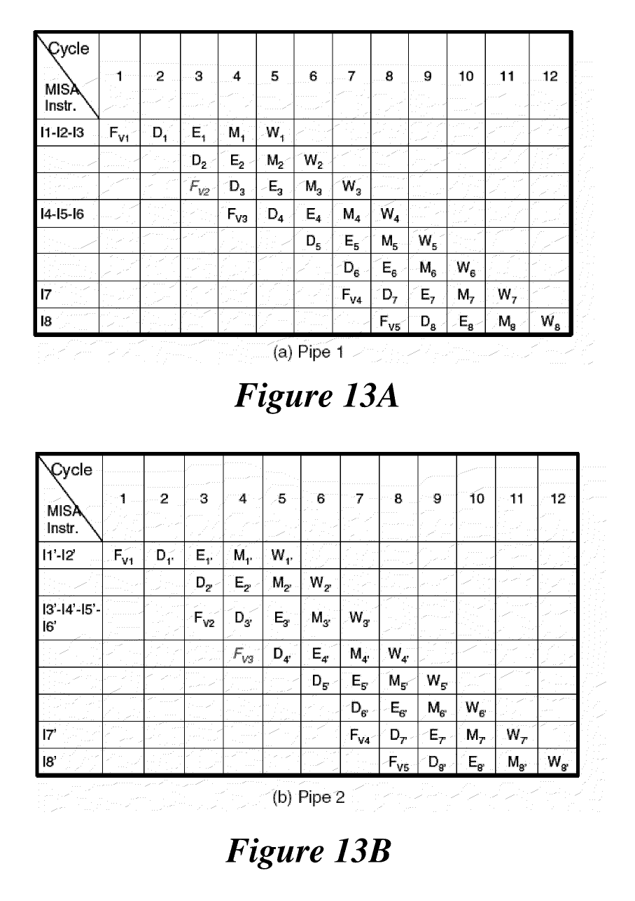

FIGS. 13A and 13B illustrate cycle-accurate behavior of pipes 1 and 2 as taught herein, respectively associated with FIG. 12, assuming all slots in an instruction word share the same fetch cycle but each has its own decode cycle, and ignoring non-ideal execution cases like multi-cycle execution, instruction/data cache miss, etc. FIGS. 13A and 13B show the following stages in an instruction cycle: fetch (F), decode (D), execute (E), memory (M), and writeback (W). Instruction word V1 (illustrated in FIG. 12) is fetched in cycle 1, V2 is fetched in cycle 3, V3 is fetched in cycle 4, V4 is fetched in cycle 7, and V5 is fetched in cycle 8. The italicized fetched behavior (e.g., F_{V2} in pipe 1) indicates that there is an instruction fetch occurring in that cycle but no MISA instruction is dispatched to the specific pipe for execution, i.e., it is a SISA instruction for other pipes.

The total execution time for the instruction sequence is twelve cycles, the same as that for a conventional multiple-issue microprocessor architecture without instruction register file (IRF) implementation. However, the number of instruction fetches in FIGS. 13A and 13B is five, as compared to eight for the conventional multiple-issue microprocessor architecture without IRF implementation.

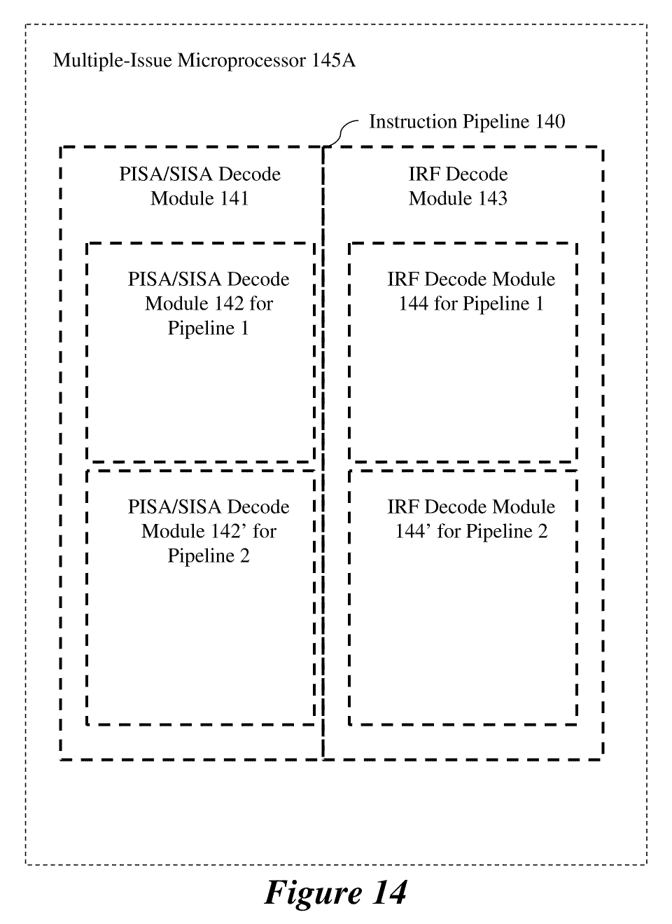

FIG. 14 illustrates a schematic diagram of a multiple-issue microprocessor 145A programmed or configured with circuitry or programmed and configured with circuitry to implement an exemplary two-pipe instruction pipeline 140 used to implement the methodology taught herein at least with respect to FIG. 11. Pipeline 140 includes a PISA/SISA decode module 141 with an input port connected to an instruction fetch module (not pictured) to receive an instruction word as input, and an output port connected to an instruction register file (IRF) decode module 143 outputs single or packed instructions contained in the instruction word in a certain scheduled order. The PISA/SISA decode module 141 contains two decode modules 142 and 142′ associated with pipes 1 and 2 of the pipeline 140, respectively.

More specifically, the PISA/SISA decode module 141 determines whether the instruction word is in a PISA or SISA format, and schedules the single or packed instructions contained in the instruction word based on the determined format. For example, if the instruction word is in a PISA format, PISA/SISA decode module 142 schedules the instruction in the instruction word associated with pipe 1 for execution in pipe 1, and PISA/SISA decode module 142′ schedules the instruction in the instruction word associated with pipe 2 for parallel execution in pipe 2. On the other hand, if the instruction word is in a SISA format associated with pipe 1, PISA/SISA decode module 142 schedules both instructions in the instruction word for sequential execution in pipe 1. Similarly, if the instruction word is in a SISA format associated with pipe 2, PISA/SISA decode module 142′ schedules both instructions in the instruction word for sequential execution in pipe 2.

IRF decode module 143 has an input port connected to the output port of the PISA/SISA decode module 141 to receive single or packed instructions contained in the instruction word in a certain scheduled order, and an output port connected to an instruction buffer to output decoded instructions for execution. The IRF decode module 143 contains two IRF decode modules 144 and 144′ associated with pipes 1 and 2 of the pipeline 140, respectively. Each IRF decode module 144 and 144′ decodes and retrieves the instructions referenced in the instruction word for execution in pipes 1 and 2, respectively. Each module retrieves packed instructions from an instruction register file (IRF).

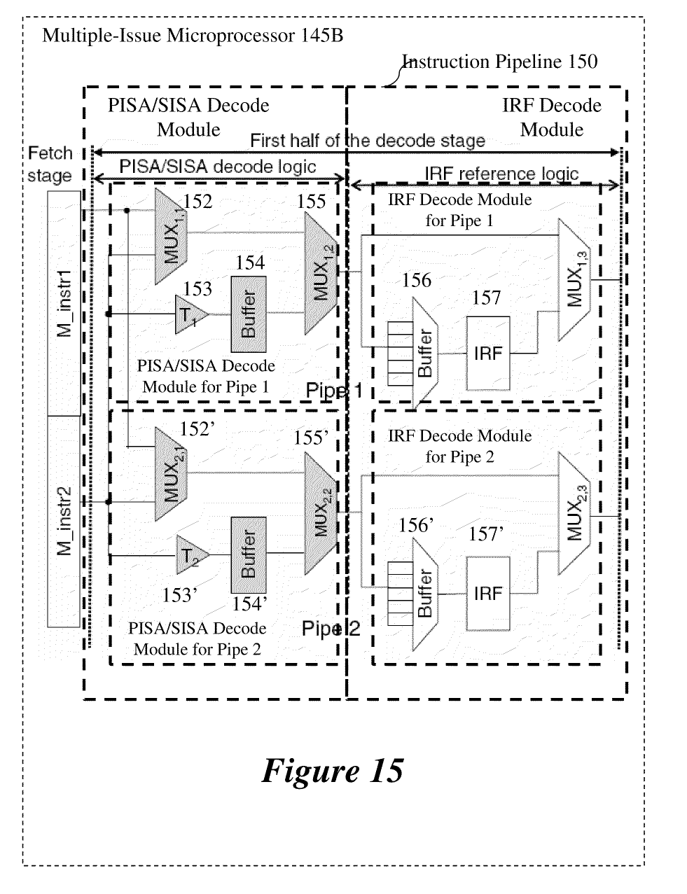

FIG. 15 schematically illustrates a specific exemplary embodiment 145B of a the multiple-issue microprocessor 145A of FIG. 14. More specifically, FIG. 15 illustrates part of an instruction decode (ID) stage of an exemplary pipeline 150 which implements an instruction register file (IRF) in a multiple-issue microprocessor according to the method illustrated in FIG. 11.

During an execution cycle, either a PISA or a SISA instruction is fetched and executed in pipeline 150. During the instruction fetch (IF) stage, each instruction is fetched from an instruction cache. During the instruction decode (ID) stage, each instruction is decoded using the pipeline illustrated in FIG. 15. For a two-way VLIW processor, each PISA/SISA instruction has two instruction slots containing two MISA instructions (M_instr1 and M_instr2). The pipeline 150 includes a PISA/SISA decode module associated with pipe 1, and a PISA/SISA decode module associated with pipe 2.

The PISA/SISA decode module associated with pipe 1 includes a multiplexer 152 with an input port connected to an instruction fetch module (not pictured) to receive instruction M_instr1 or M_instr2 as input. The decode module also includes a tri-state gate 153 with an output port connected to an input port of a buffer 154. The output ports of the multiplexer 152 and the buffer 154 are connected to an input port of a multiplexer 155. Multiplexer 155 has an output port connecting to an input port of an IRF decode module associated with pipe 1. Similarly, the PISA/SISA decode module associated with pipe 2 includes a multiplexer 152′ with an input port connected to an instruction fetch module (not pictured) to receive instruction M_instr1 or M_instr2 as input. The decode module also includes a tri-state gate 153′ with an output port connected to an input port of a buffer 154′. The output ports of the multiplexer 152′ and the buffer 154′ are connected to an input port of a multiplexer 155′. Multiplexer 155′ has an output port connecting to an input port of an IRF decode module associated with pipe 1.

If the incoming instruction is a regular PISA instruction, exemplary embodiments generate signals for multiplexers 152, 155 to select and pass M_instr1 to the IRF decode module associated with pipe 1 for execution in pipe 1. Similarly, exemplary embodiments generate signals for multiplexers 152′, 155′ to select and pass M_instr2 to the IRF decode module associated with pipe 2 for execution in pipe 2. As a result, M_instr1 and M_instr2 are scheduled for parallel execution in pipes 1 and 2, respectively.

If the incoming instruction is a SISA instruction, exemplary embodiments determine if the SISA instruction is scheduled for execution in pipe 1 or pipe 2. If the SISA instruction is meant for execution in pipe 1, exemplary embodiments generate signals for multiplexer 152 to select M_instr1 and enable the tri-state gate 153 to buffer M_instr2 for future execution. Exemplary embodiments generate a control signal for multiplexer 155 to feed M_instr1 and M_instr2 sequentially to the IRF decode module associated with pipe 1. As a result, M_instr1 and M_instr2 are scheduled for sequential execution in pipe 1.

Similarly, if the SISA instruction is meant for execution in pipe 2, exemplary embodiments generate signals for multiplexer 152′ to select M_instr1 and enable the tri-state gate 153′ to buffer M_instr2 for future execution. Exemplary embodiments generate control signal for multiplexer 155′ to feed M_instr1 and M_instr2 sequentially to the IRF decode module associated with pipe 2. As a result, M_instr1 and M_instr2 are scheduled for sequential execution in pipe 2.

The pipeline 150 includes IRF decode modules, each associated with a processor pipe. After the PISA/SISA decode stage, each IRF decode logic module interprets the instruction associated with the corresponding pipe, and issues either a single sub-instruction to the targeted pipe (if the instruction slot contains a single sub-instruction), or refers to multiple RISA instructions (if the instruction slot contains a packed instruction) in the IRF and issues the instructions sequentially to the targeted pipe. The IRF decode modules associated with pipes 1 and 2 include IRF 157 and 157′, respectively. Frequently accessed instructions contained in packed instructions may be retrieved from the IRFs for execution.

To successfully fetch SISA instructions to compensate the vertical execution length mismatch, a new instruction should be fetched as long as one of the pipes has finished all its sub-instructions. This can be implemented by a fetch enable logic generator (not pictured) in the instruction fetch (IF) stage. A status signal is generated for each pipe when the pipe is empty. An OR logic is used to take in the two pipes' status signals and output a fetch control signal for the instruction cache in the IF stage.

There are several non-ideal execution cases, such as multi-cycle instruction execution, instruction cache miss, and data cache miss, which need to be handled by the enhanced VLIW architecture. On an instruction or data cache miss, all the pipes are stalled, just in the same way as the original VLIW architecture. In addition, the buffers 156, 156′ used in the IRF decode modules stop issuing RISA instructions to avoid dynamic execution hazards. For multi-cycle execution, since it occurs in the pipeline stage later than the decode stage, where exemplary instruction packing and IRF referencing mechanism take place, the handling mechanisms are transparent to the packing methods of exemplary embodiments. For example, the stalls caused by multi-cycle execution can be implemented by NOP insertion at compile-time. At runtime, the sub-instructions of each slot are recovered to the original execution sequence after IRF referencing. Thus, the multi-cycle handling mechanism for the original VLIW architecture applies to exemplary embodiments.

An integrated compilation and performance simulating environment was used to test exemplary embodiments illustrated in FIG. 15 on a four-way VLIW processor. The processor configuration included four slots, four integer units, two floating units, two memory units, and one branch unit. The original VLIW program code was generated by a compiler, and a modified simulator was used to profile the program for run-time information. The profiling data was used to select the best candidate instructions for an instruction register file (IRF). Then, the program was modified and reorganized in accordance with exemplary embodiments, including MISA, PISA and SISA instructions. The instruction packing was restricted within hyper-blocks of VLIW code and did not include branch instructions. The modified program was then simulated to obtain execution statistics.

A set of benchmarks were tested to evaluate the effectiveness of exemplary embodiments in code size reduction and energy saving. The benchmarks represent typical embedded applications for VLIW architectures, such as system commands (strcpy and wc), matrix operations (bmm and mm_double), arithmetic functions (hyper and eight), and other special test programs (wave and test_install).

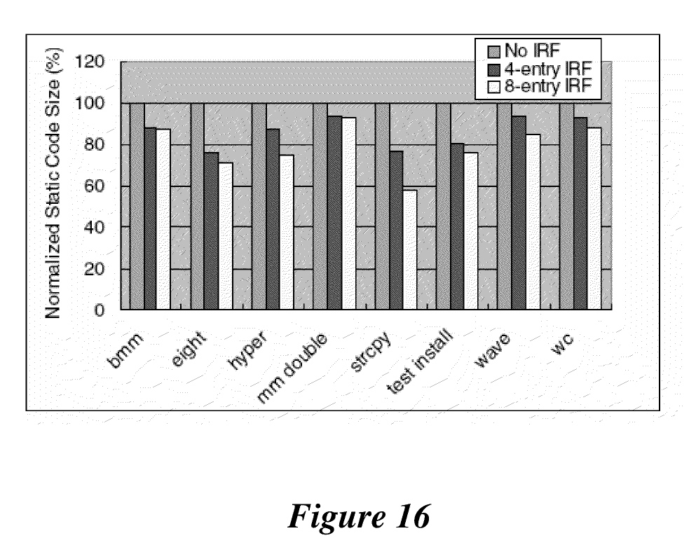

Results showed that the program memory size was reduced through instruction packing in accordance with exemplary embodiments. The program code size achieved by exemplary embodiments was compared with that under traditional VLIW code compression where all the No Operation Performed (NOPs) were removed. FIG. 16 is a bar graph of code reduction over eight benchmarks applications executed by instruction packing in accordance with exemplary embodiments (4-entry IRF and 8-entry IRF) as compared with traditional VLIW code compression (No IRF). Over the eight benchmarks, the average reduction rate of the static code size was 14.9% for VLIW processors with 4-entry IRFs, and 20.8% for 8-entry IRFs.

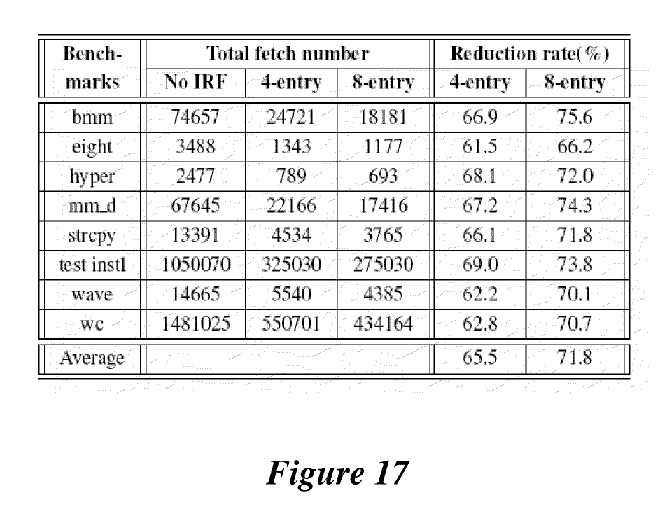

FIG. 17 is a table that shows the instruction fetch numbers under different IRF implementations provided by exemplary embodiments as compared with no IRF implementation. The fetch number was reduced greatly for a 4-way enhanced VLIW processor. The average reduction rate over the eight benchmark applications was 65.5% for 4-entry IRFs and 71.8% for 8-entry IRFs. The reduction rate for a 4-way VLIW processor with 4-entry IRFs was larger than that for a single-issue processor with a 16-entry IRF, due to the advantage of selecting sub-instructions of different slots separately for IRFs in the approach provided by exemplary embodiments.

Previous research has shown that the instruction fetch energy can reach up to 30% of the total energy for current embedded processors. The large reduction in the total fetch number achieved by exemplary embodiments can save a lot of instruction fetch energy, and thus reduce the total energy consumption significantly. The following simple energy estimation model is adopted for estimating the fetching energy consumed by both instruction cache access and IRF referencing:

E_{fetch}=100*Num_{Instruction}_{_{—}}_{cache}_{_{—}}_{access}+Num_{IRF}_{_{—}}_{access}

In the above model, the energy cost for accessing the L1 instruction cache is 100 times of the energy cost of accessing the IRF due to the tagging and addressing logic. For simplicity, we assumed that all of the VLIW instruction fetches hit in the L1 instruction cache, and ignored the extra cache miss energy consumption. In reality, with smaller code size and fewer cache misses, the energy reduction achieved by exemplary embodiments would be larger.

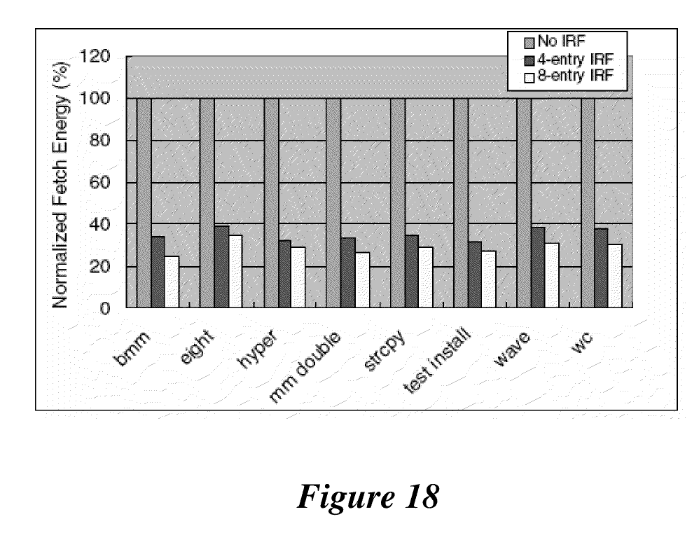

FIG. 18 is a bar graph of fetch energy reduction achieved by exemplary embodiments for a 4-way VLIW architecture with the IRF size varying between 4 and 8. The average reduction rate of the fetch energy consumption for VLIW architectures with 4-entry IRFs was 64.8% and 71.1% for 8-entry IRFs.

As the approach provided by exemplary embodiments recovers the original VLIW sub-instruction sequence for execution at run-time, the multiple-issue VLIW instruction execution can be preserved without any performance degradation. Exemplary embodiments add simple PISA/SISA decoding in the instruction decode stage, which may introduce a small delay and negligible energy overhead in the decode cycle. However, since normally the critical path or pipeline is in the instruction execution stage, the clock cycle time is unlikely to be increased by the extra decoding logic provided by exemplary embodiments. If for some architectures this is not the case, the PISA/SISA decoding logic can be moved to the end of the instruction fetch stage in exemplary embodiments to shorten the critical path of the instruction decode stage.

In the above experiments on exemplary embodiments, the maximum number of RISAs in a MISA instruction was set to 5, which was used for an IRF with 32 entries and instruction word length of 32 bits. In the experiments, when the IRF entry number is reduced to 4 or 8, the index bit-length changes to 2 or 3, and more IRF instructions may be referred to by one MISA instruction. These changes are expected to lead to even larger static code size reduction and higher fetch energy saving.

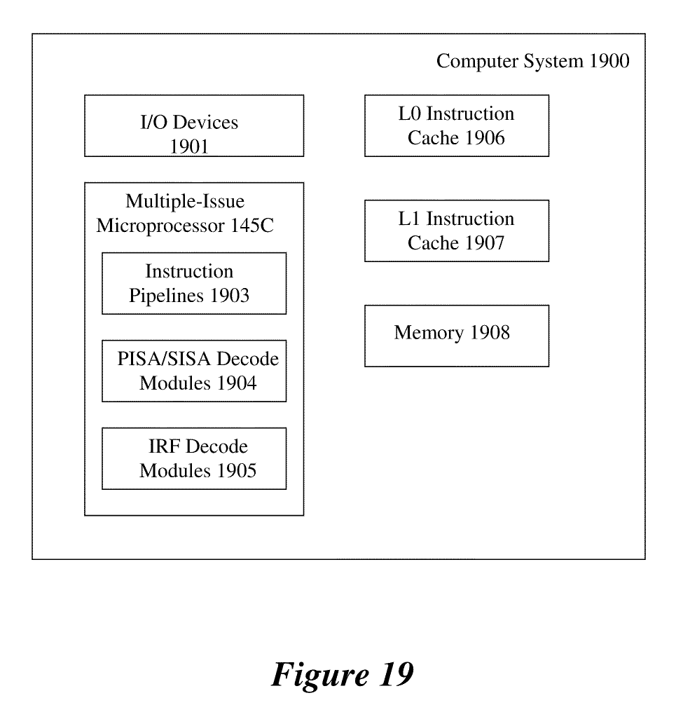

FIG. 19 is a block diagram of an exemplary computer system 1900 for implementing a multiple-issue microprocessor in accordance with exemplary embodiments. Computer system 1900 includes one or more input/output (I/O) devices 1901, such a keyboard or a multi-point touch interface and/or a pointing device, for example a mouse, for receiving input from a user. The I/O devices 1901 may be connected to a visual display device that displays aspects of exemplary embodiments to a user, e.g., an instruction or results of executing an instruction, and allows the user to interact with the computing system 1900. Computing system 1900 may also include other suitable conventional I/O peripherals. Computing system 1900 may further include one or more storage devices, such as a hard-drive, CD-ROM, or other computer readable media, for storing an operating system and other related software used to implement exemplary embodiments. The computer-readable media may include, but are not limited to, one or more types of hardware memory, non-transitory tangible media, etc. For example, memory 1908 included in the computer system 1900 may store computer-executable instructions or software, e.g., instructions for implementing and processing every module of the microprocessor 145C, and for implementing every functionality provided by exemplary embodiments.

Computer system 1900 includes a multiple-issue microprocessor 145C which is programmed to and/or configured with circuitry to implement one or more instruction pipelines 1903, one or more PISA/SISA decode modules 1904 (each PISA/SISA decode module being associated with an instruction pipeline), and one or more instruction register file (IRF) decode modules 1905 (each IRF decode module being associated with an instruction pipeline).

Computer system 1900 also includes one or more instruction caches that hold instructions and from which microprocessor 145C may fetch one or more instructions. For example, computer system 1900 may include an L0 instruction cache 1906 and an L1 instruction cache 1907.

One of ordinary skill in the art will appreciate that the present invention is not limited to the specific exemplary embodiments described herein. Many alterations and modifications may be made by those having ordinary skill in the art without departing from the spirit and scope of the invention. Therefore, it must be expressly understood that the illustrated embodiments have been shown only for the purposes of example and should not be taken as limiting the invention, which is defined by the following claims. These claims are to be read as including what they set forth literally and also those equivalent elements which are insubstantially different, even though not identical in other respects to what is shown and described in the above illustrations.

What is claimed is:

1. In a multiple-issue microprocessor comprising at least a plurality of instruction pipelines, a method for scheduling an instruction to maintain synchronization amongst the plurality of instruction pipelines in the microprocessor, the method comprising:
receiving an instruction having first and second sub-instructions;
determining a format of the instruction prior to scheduling the instruction for execution; and
based on the result of determining the format, scheduling the first and second sub-instructions for sequential execution in a first instruction pipeline, or scheduling the first and second sub-instructions for parallel execution in the first instruction pipeline and a second instruction pipeline, respectively.

2. The method of claim 1, wherein the format of the instruction is a parallel instruction set architecture (PISA) format indicating that the first and second sub-instructions are configured for parallel execution, and wherein the method schedules the first and second sub-instructions for parallel execution in the first and second instruction pipelines, respectively.

3. The method of claim 1, wherein the format of the instruction is a sequential instruction set architecture (SISA) format indicating that the first and second sub-instructions are configured for sequential execution in the first instruction pipeline, and wherein the method schedules the first and second sub-instructions for sequential execution in the first instruction pipeline.

4. The method of claim 1, wherein the first sub-instruction or the second sub-instruction is a packed instruction.

5. The method of claim 4, further comprising:
retrieving the packed instruction from an instruction register file (IRF).

6. The method of claim 1, further comprising:
executing the first and second sub-instructions based on the scheduling.

7. A multiple-issue microprocessor, comprising:
a first instruction pipeline for decoding and executing one or more sub-instructions;
a second instruction pipeline for decoding and executing one or more sub-instructions; and
an instruction format decode module that:
receives an instruction comprising first and second sub-instructions,
determines a format of the instruction prior to scheduling the instruction for execution, and
based on the result of determining the format, schedules the first and second sub-instructions for sequential execution in the first instruction pipeline, or schedules the first and second sub-instructions for parallel execution in the first and second instruction pipelines, respectively.

8. The microprocessor of claim 7, wherein the format of the instruction is a parallel instruction set architecture (PISA) format indicating that the first and second sub-instructions are configured for parallel execution, and wherein the instruction format decode module schedules the first and second sub-instructions for parallel execution in the first and second instruction pipelines, respectively.

9. The microprocessor of claim 8, wherein the instruction format decode module comprises:
a first multiplexer associated with the first instruction pipeline for selecting the first sub-instruction for scheduling in the first instruction pipeline; and
a second multiplexer associated with the second instruction pipeline for selecting the second sub-instruction for scheduling in the second instruction pipeline.

10. The microprocessor of claim 7, wherein the format of the instruction is a sequential instruction set architecture (SISA) format indicating that the first and second sub-instructions are configured for sequential execution in the first instruction pipeline, and wherein the instruction format decode module schedules the first and second sub-instructions for sequential execution in the first instruction pipeline.

11. The microprocessor of claim 10, wherein the instruction format decode module comprises:
a multi-state gate for buffering the second sub-instruction for execution in a second cycle; and
a multiplexer associated with the first instruction pipeline for selecting the first sub-instruction for scheduling in the first instruction pipeline during a first cycle and for selecting the buffered second sub-instruction for scheduling in the first instruction pipeline during the second cycle.

12. The microprocessor of claim 7, wherein the first sub-instruction or the second sub-instruction is a packed instruction.

13. The microprocessor of claim 12, further comprising:
an instruction reference decode module comprising for retrieving the packed instruction from an instruction register file (IRF).

14. The microprocessor of claim 7, further comprising:
an execution module for executing the first and second sub-instructions based on the scheduling.

15. The microprocessor of claim 7, wherein the instruction format decode module is programmed or configured with circuitry or programmed and configured with circuitry to receive the instruction, determine the format, and schedule the first and second sub-instructions for sequential execution or parallel execution.

16. A computer system, comprising:
memory for storing one or more instructions; and
a multiple-issue microprocessor, comprising:
a first instruction pipeline for decoding and executing one or more sub-instructions;
a second instruction pipeline for decoding and executing one or more sub-instructions; and
an instruction format decode module that:
receives an instruction comprising first and second sub-instructions,
determines a format of the instruction prior to scheduling the instruction for execution, and
based on the result of determining the format, schedules the first and second sub-instructions for sequential execution in the first instruction pipeline, or schedules the first and second sub-instructions for parallel execution in the first and second instruction pipelines, respectively.

17. The computer system of claim 16, wherein the format of the instruction is a parallel instruction set architecture (PISA) format indicating that the first and second sub-instructions are configured for parallel execution, and wherein the instruction format decode module schedules the first and second sub-instructions for parallel execution in the first and second instruction pipelines, respectively.

18. The computer system of claim 17, wherein the instruction format decode module comprises:
a first multiplexer associated with the first instruction pipeline for selecting the first sub-instruction for scheduling in the first instruction pipeline; and
a second multiplexer associated with the second instruction pipeline for selecting the second sub-instruction for scheduling in the second instruction pipeline.

19. The computer system of claim 16, wherein the format of the instruction is a sequential instruction set architecture (SISA) format indicating that the first and second sub-instructions are configured for sequential execution in the first instruction pipeline, and wherein the instruction format decode module schedules the first and second sub-instructions for sequential execution in the first instruction pipeline.

20. The computer system of claim 19, wherein the instruction format decode module comprises:
a multi-state gate for buffering the second sub-instruction for execution in a second cycle; and
a multiplexer associated with the first instruction pipeline for selecting the first sub-instruction for scheduling in the first instruction pipeline during a first cycle and for selecting the buffered second sub-instruction for scheduling in the first instruction pipeline during the second cycle.

21. The computer system of claim 16, wherein the first sub-instruction or the second sub-instruction is a packed instruction.

22. The computer system of claim 21, wherein the multiple-issue microprocessor further comprises:
an instruction reference decode module comprising for retrieving the packed instruction from an instruction register file (IRF).

23. The computer system of claim 16, wherein the multiple-issue microprocessor further comprises:
an execution module for executing the first and second sub-instructions based on the scheduling.

24. The computer system of claim 16, wherein the instruction format decode module is programmed or configured with circuitry or programmed and configured with circuitry to receive the instruction, determine the format, and schedule the first and second sub-instructions for sequential execution or parallel execution.
